(19) United States
(12) Patent Application Publication
(10) Pub. No.: US 2009/0042084 A1
(43) Pub. Date: Feb. 12, 2009

(54) Separator for fuel cell and method for manufacturing the same

(76) Inventors: Koji Kobayashi, Tochigi-ken (JP); Masaharu Kitafuji, Saitama-ken (JP); Nobuhiro Asai, Tochigi-ken (JP); Tetsuya Kondo, Tochigi-ken (JP); Yu Kawamata, Tochigi-ken (JP); Yasuhiro Nakao, Tochigi-ken (JP)

Correspondence Address: ARENT FOX LLP, 1050 CONNECTICUT AVENUE, N.W., SUITE 400, WASHINGTON, DC, 20036, US

(21) Appl. No.: 11/919,631

(22) PCT Filed: Jun. 2, 2006
(86) PCT No.: PCT/JP2006/311125

§ 371 Date: Oct. 31, 2007

(30) Foreign Application Priority Data
Jun. 3, 2005 (JP) 2005-164317

(51) Int. Cl. H01M 2/14; C25D 3/56; C25D 3/62; C25D 3/50; C25D 3/48

(52) U.S. Cl. 429/34; 205/257; 205/247; 205/264; 205/266; 205/267

(57) ABSTRACT

At first step S1, a passivation film is removed by performing pickling on a separator for fuel cell and then a new passivation film is formed b performing heating at 200-280° preferably. At second step S2, mechanical polishing is performed on the horizontal top surfaces in the waiving portion of the separator for fuel cell, and a chipped portion is provided by chipping off a part of the passivation film. At third step S3, the separator for fuel cell is plated to form a first plating film composed of gold, rhodium, platinum or an alloy of two or more kinds of them starting at the periphery of the chipped portion. A complex ion stabilizer for suppressing dissociation of complex ions is added to plating bath.

### TECHNICAL FIELD

The present invention relates to a separator for a fuel cell in which a plating coating film is selectively provided on horizontal top surfaces of protrusions that form a wavy portion, and a method for manufacturing the same.

### BACKGROUND ART

In recent years, fuel cells have attracted attention as concerns increase concerning environmental protection, for the following reason. Specifically, only H₂O is generated in the fuel cell, and atmospheric air is not polluted thereby.

As shown in FIG. 10, a fuel cell 10 is constructed as a stack made up of a plurality of stacked unit cells 12. In the unit cell 12, an electrolyte-electrode assembly 20, in which an electrolyte or an ion exchange membrane 18 intervenes between an anode 14 and a cathode 16, is interposed between a pair of separators 22, 22 constituting the fuel cell. In general, for example, stainless steel or a titanium alloy is selected as the material for the fuel cell separators 22.

Each of the fuel cell separators 22 is provided with a wavy portion 28 having first protrusions 24 and second protrusions 26, which continue alternately and protrude in mutually opposite directions, such that a fuel gas containing hydrogen is supplied to the anode 14, and an oxygen-containing gas containing oxygen is supplied to the cathode 16. Horizontal top surfaces 24a, 26a are provided on the first protrusions 24 and the second protrusions 26, respectively.

When the stack is constructed, for example, the horizontal top surfaces 24a of the first protrusions 24 contact the anode 14, and the horizontal top surfaces 26a of the second protrusions 26 contact the cathode 16. The oxygen-containing gas flows through clearances 30 formed between the first protrusions 24 and the cathode 16, whereas the fuel gas flows through clearances 32 formed between the second protrusions 26 and the anode 14. More specifically, the wavy portion 28 functions as supply grooves for supplying reaction gases to the electrodes 14, 16.

As clearly appreciated from the above, the respective horizontal top surfaces 24a, 26a of the first protrusions 24 and the second protrusions 26 abut against other members. If the contact resistance is excessively high at the abutting portions, the internal resistance of the fuel cell 10 is increased. In view of the above, it has been suggested that a gold plating coating film should be provided on the horizontal top surfaces 24a, 26a, in order to reduce the contact resistance of the horizontal top surfaces 24a, 26a (see, for example, Patent Document 1).

However, an oxide film, which is spontaneously generated by a reaction with oxygen in the air, i.e., a passivation film, is present on the surface of, for example, stainless steel and the titanium alloy. If such a passivation film, which remains after plating, has an excessively large thickness, it becomes difficult to reduce contact resistance, even when a gold plating coating film is provided.

The gold plating coating film is deposited using boride, serving as starting points. In this case, the gold plating coating film forms a dispersed coating film, in which relatively giant granular or particulate matter, having particle sizes of 3,000 to 8,000 nm, are scattered and dotted in an island form. Thus, in the case of the gold plating coating film described above, it is not easy to significantly reduce contact resistance of the horizontal top surfaces 24a, 26a.

In view of the above, it has been suggested in Patent Document 2 that a noble metal should be adhered to stainless steel, immediately after a passivation film on the stainless steel is removed, by polishing with a polishing agent adhered with the noble metal.

Patent Document 1: Japanese Laid-Open Patent Publication No. 10-228914;

Patent Document 2: Japanese Laid-Open Patent Publication No. 2002-134128.

### DISCLOSURE OF THE INVENTION

In the case of the technique described in Patent Document 2, polishing is performed while both end surfaces of the stainless steel are interposed under the pressure of a roller, while the noble metal is adhered thereto. Therefore, it is difficult to perform polishing after the wavy portion has been provided because, in this case, there is a concern that the wavy portion may become crushed, since both end surfaces of the wavy portion are interposed under pressure during polishing.

To avoid this inconvenience, if polishing and adhesion of the noble metal are performed on flat stainless steel, prior to producing the wavy portion, another inconvenience arises in that production costs for the separator become expensive, because the noble metal is expensive, as is well known.

A general object of the present invention is to provide a fuel cell separator, in which the contact resistance of horizontal top surfaces is selectively reduced, when such surfaces make contact with another member.

A principal object of the present invention is to provide a fuel cell separator, which can be supplied inexpensively.

Another object of the present invention is to provide a fuel cell separator, which suffers only slightly from galvanic corrosion, and which exhibits excellent corrosion resistance.

Still another object of the present invention is to provide a method for producing a fuel cell separator, which enables the contact resistance of horizontal top surfaces thereof to be selectively reduced.

Still another object of the present invention is to provide a method for producing a fuel cell separator, which can be carried out at a low cost.

According to one aspect of the present invention, there is provided a fuel cell separator comprising a wavy portion including first protrusions and second protrusions, which are disposed alternately and continuously, the first protrusions protruding in a predetermined direction and having horizontal top surfaces, and the second protrusions protruding in a direction opposite to the direction of the first protrusions, and having horizontal top surfaces exposed on a side opposite to a side on which the horizontal top surfaces of the first protrusions are exposed,

wherein a first plating coating film, composed of a dispersed coating film, containing one of gold, rhodium, platinum, and an alloy of two or more thereof, and deposited in an island form as granules having particle sizes of 20 to 60 μm, is provided on the horizontal top surfaces of at least one of the first protrusions and the second protrusions, while a second plating coating film, composed of a dispersed coating film, containing one of gold, rhodium, platinum, and an alloy of two or more thereof, and deposited in an island form as granules having particle sizes of 20 to 60 μm, is provided on back surfaces of the second protrusions or the first protrusions with respect to the horizontal top surfaces, the back surfaces being adjacent to the horizontal top surfaces, and

wherein an amount of the first plating coating film is not less than 1,000 times an amount of the second plating coating film.

In the present invention, the plating coating film is selectively formed on the horizontal top surfaces, which abut against another member. That is, the plating coating film, composed of the expensive noble metal, is formed within a narrow range. Therefore, it is possible to provide separators for the fuel cell inexpensively. Further, contact resistance when the fuel cell is constructed can be reduced, due to the presence of the plating coating film.

Further, the plating coating film is selectively provided. Therefore, an advantage is also obtained in that the weight of the plating coating film itself, as well as the total weight of the fuel cell separator, is reduced, compared to a case in which a plating coating film is provided over the entire surface of the fuel cell separator.

Further, the plating coating film is provided as a dispersed coating film, in which granular or particulate matter having particle sizes of 20 to 60 μm are scattered and dotted in an island form. Therefore, even when a corrosion current occurs between the plating coating film and the underlying metal, the corrosion current is dispersed. Therefore, the passivation film is not destroyed, and galvanic corrosion is not caused.

In the above described construction, it is preferable that the amount of the plating coating film formed on the horizontal top surfaces of the first protrusions or the second protrusions is not less than 10,000 times the amount of the plating coating film formed on the back surfaces of the second protrusions or the first protrusions, with respect to the horizontal top surfaces, the back surfaces being disposed adjacent to the horizontal top surfaces.

It is preferable for the passivation film, which is provided on portions other than the horizontal top surfaces, to have a thickness of not less than 4 nm. Owing to this arrangement, since insulation performance is assured at portions other than the horizontal top surfaces, concerns over electrical leakage and/or short circuiting are eliminated. The passivation film preferably has a thickness of 4 to 5 nm.

When stainless steel is selected as the material for the fuel cell separator, the principal component of the passivation film changes in the depth direction. Specifically, the principal component becomes Cr on a side nearest to the stainless steel (in the vicinity of the deepest portion). On the other hand, the principal component becomes Fe within a region ranging from a substantially middle portion toward the surface layer portion, in the depth direction.

When a coating ratio of the first plating coating film with respect to the horizontal top surfaces is not more than 70%, it becomes extremely difficult for galvanic corrosion to occur. On the other hand, if the coating ratio is less than 16%, the reduction in contact resistance of the horizontal top surfaces is poor. Consequently, it is preferable for the coating ratio to be 16% to 70%.

According to another aspect of the present invention, a method for producing a fuel cell separator is provided, comprising a wavy portion including first protrusions and second protrusions, which are disposed alternately and continuously, the first protrusions protruding in a predetermined direction and having horizontal top surfaces, and the second protrusions protruding in a direction opposite to the direction of the first protrusions, and having horizontal top surfaces exposed on a side opposite to a side on which the horizontal top surfaces of the first protrusions are exposed, wherein a first plating coating film, composed of a dispersed coating film, containing one of gold, rhodium, platinum, and an alloy of two or more thereof, and deposited in an island form as granules having particle sizes of 20 to 60 μm, is provided on the horizontal top surfaces of at least one of the first protrusions and the second protrusions, while a second plating coating film, composed of a dispersed coating film, containing one of gold, rhodium, platinum, and an alloy of two or more thereof, and deposited in an island form as granules having particle sizes of 20 to 60 μm, is provided on back surfaces of the second protrusions or the first protrusions with respect to the horizontal top surfaces, the back surfaces being adjacent to the horizontal top surfaces, and wherein an amount of the first plating coating film is not less than 1,000 times an amount of the second plating coating film, the method comprising the steps of:

removing a passivation film existing on the wavy portion provided for the fuel cell separator;

providing a new passivation film on the wavy portion, and then applying mechanical polishing to the horizontal top surfaces of at least one of the first protrusions and the second protrusions, thereby providing defect portions on the passivation film existing on the horizontal top surfaces; and

applying a plating treatment to the fuel cell separator with a plating bath, containing at least one selected from the group consisting of gold complex salt, rhodium complex salt, and platinum complex salt, so as to selectively provide the plating coating film on the horizontal top surfaces using as starting points circumferential portions of the defect portions.

More specifically, in the present invention, a passivation film, which is originally present, is initially removed by means of acid washing, and then a large number of defects are provided in a newly provided passivation film by means of mechanical polishing only at portions existing on the horizontal top surfaces. Thereafter, a plating coating film is deposited from circumferential portions of the defect portions. On the other hand, the plating coating film is scarcely formed on portions other than the horizontal top surfaces on which mechanical polishing is not applied.

Therefore, in the present invention, the plating coating film is selectively formed on the horizontal top surfaces. In other words, portions where the plating coating film is formed can be limited to a minimum necessary amount. Therefore, the fuel cell separator can be produced at a low cost.

Operations performed on the preformed member are convenient, including only acid washing, mechanical polishing, and a plating treatment. It is unnecessary to perform complicated operations including, for example, execution and removal of masking. Moreover, it is unnecessary to provide any new equipment.

The separator for the fuel cell, obtained as described above, can be provided inexpensively. Further, the occurrence of galvanic corrosion in the fuel cell separator is suppressed significantly. That is, the obtained fuel cell separator possesses excellent corrosion resistance.

Further, in the present invention, it is unnecessary to interpose the wavy portion under pressure. Therefore, the wavy portion does not become crushed, and it is possible to manufacture a fuel cell separator having excellent dimensional accuracy.

When the plating treatment is performed, it is preferable that a complex ion stabilizer be added to the plating liquid. Accordingly, dissociation of complex ions into the metal ion is suppressed. Therefore, it is difficult for metal ions to be deposited as metal, and consequently, metal ions are scarcely deposited as the coating film, at portions where a nucleus of the defect is absent. Therefore, formation of the plating coating film is even further selectively advanced.

Preferred examples of the complex ion stabilizer include at least one of phosphate salt, carboxylate salt, and sodium salt.

Preferred examples of the phosphate salt include sodium dihydrogen phosphate (NaH₂PO₄) and sodium diphosphate (Na₄P₂O₇). The phosphate salt may be a hydrate including, for example, Na₄P₂O₇.10H₂O.

Preferred examples of the carboxylate salt include trisodium citrate (C₆H₅O₇Na₃). The carboxylate salt may be a hydrate such as C₆H₅O₇Na₃.2H₂O.

Further, preferred examples of the sodium salt include sodium sulfite (Na₂SO₃) and sodium tetraborate (Na₂B₄O₇).

In this process, the new passivation film also can be formed, for example, wherein the fuel cell separator is exposed to air or oxygen after performing acid washing, and before performing a subsequent step. However, it is preferable that heating be performed at a temperature of 200 to 280° C., so that when heating is performed within this temperature, a passivation film can easily be obtained, which has a thickness of not less than 4 nm, and also which exhibits excellent insulation performance. Further, the amount of the first plating coating film differs significantly from the amount of the second plating coating film.

### BRIEF DESCRIPTION OF THE DRAWINGS

FIG. 1 is a schematic perspective view illustrating an entire fuel cell separator, according to an embodiment of the present invention;

FIG. 2 is an enlarged sectional view illustrating principal components of a wavy portion of the fuel cell separator shown in FIG. 1;

FIG. 3 is an SEM photograph, at 40000L× magnification, of a first plating coating film that exists on a horizontal top surface of the wavy portion shown in FIG. 2;

FIG. 4 is a graph illustrating the relationship between contact resistance and surface pressure (contact pressure) of horizontal top surfaces of respective wavy portions of the fuel cell separator, according to the embodiment of the present invention and a fuel cell separator concerning the conventional technique;

FIG. 5 is an enlarged sectional view illustrating principal components of the wavy portion of a preformed member to be converted into the fuel cell separator shown in FIG. 1;

FIG. 6 is a flow chart illustrating a method for producing the fuel cell separator according to the embodiment of the present invention;

FIG. 7 is an enlarged sectional view illustrating principal components of the wavy portion and depicting a state in which a new passivation film is generated;

FIG. 8 is an enlarged sectional view illustrating principal components of the wavy portion and depicting a state in which the wall thickness of the passivation film is further reduced and defect portions are formed;

FIG. 9 is an enlarged sectional view illustrating principal components of the wavy portion and depicting a state in which a horizontal top surface thereof is coated with a gold plating coating film; and

FIG. 10 is an enlarged sectional view illustrating principal components of the fuel cell stack.

### BEST MODE FOR CARRYING OUT THE INVENTION

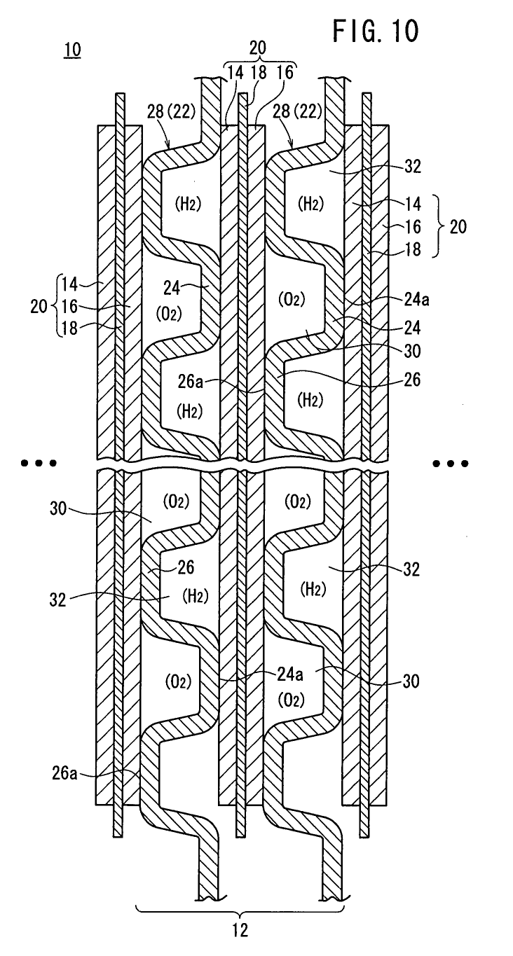

A fuel cell separator according to the present invention, and a method for manufacturing the same, shall be explained in detail below with reference to the accompanying drawings, in which preferred embodiments of the present invention are presented. Constitutive components, which are the same as those shown in FIG. 10, are designated by the same reference numerals, and detailed explanations of such features shall be omitted.

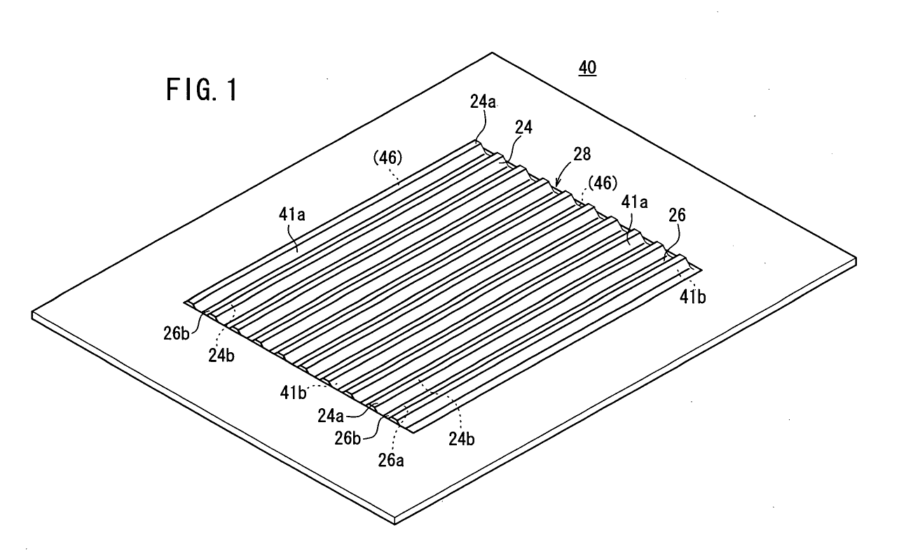

FIG. 1 is a schematic perspective view illustrating an entire fuel cell separator 40, according to an embodiment of the present invention. A wavy portion 28 is provided, for example, by means of a press forming process, on the fuel cell separator 40, which is composed of stainless steel.

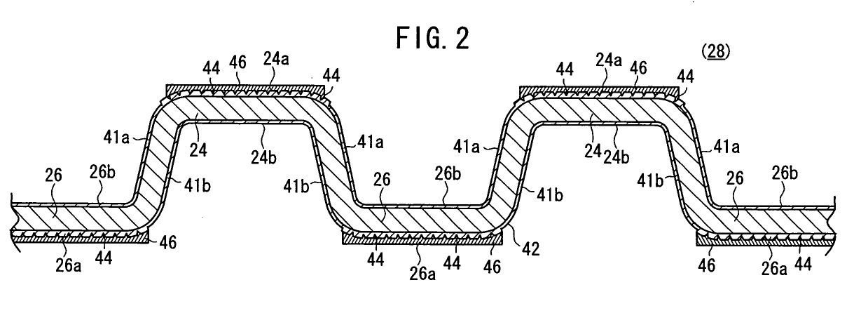

As shown in FIG. 2, the wavy portion 28 includes first protrusions 24, which protrude from one end surface of the fuel cell separator 40, together with second protrusions 26, which protrude in a direction opposite to the first protrusions 24, such that the first and second protrusions 24, 26 continue alternately. Horizontal top surfaces 24a, 26a exist on the first protrusions 24 and the second protrusions 26, respectively.

The horizontal top surface 24a and the horizontal top surface 26a form surfaces that are exposed in mutually opposite directions. More specifically, in relation to the first protrusion 24, the surface exposed in the same direction as that of the horizontal top surfaces 26a, 26a of the adjoining second protrusions 26, 26 forms a bottom surface 24b, whereas the back surface of the bottom surface 24b forms a horizontal top surface 24a. Similarly, in relation to the second protrusion 26, the surface exposed in the same direction as that of the horizontal top surfaces 24a, 24a of the adjoining first protrusions 24, 24 forms a bottom surface 26b, whereas the back surface thereof forms a horizontal top surface 26a. Accordingly, the horizontal top surface 24a of the first protrusion 24 abuts against the anode 14, and the horizontal top surface 26a of the second protrusion 26 abuts against the cathode 16, for example (see FIG. 10).

In the following description, both the inclined surface directed from the horizontal top surface 24a to the bottom surface 26b, as well as the inclined surface directed from the bottom surface 26b to the horizontal top surface 24a, are generally referred to as “first inclined surfaces 41a”. Further, both the inclined surface directed from the horizontal top surface 26a to the bottom surface 24b, as well as the inclined surface directed from the bottom surface 24b to the horizontal top surface 26a, are generally referred to as “second inclined surfaces 41b” (see FIG. 2). As clearly appreciated from FIG. 2, the first inclined surface 41a and the second inclined surface 41b are in a relationship whereby they mutually form front and back surfaces.

The surface of the wavy portion 28, constructed as described above, is coated as a whole with the passivation film 42. Defect portions 44 are formed on upper end surface portions of the passivation film 42, where the horizontal top surfaces 24a, 26a are subjected to coating. Further, the first plating coating film 46 is provided selectively thereon.

That is, the existence of the first plating coating film 46 can be confirmed visually on the horizontal top surfaces 24a, 26a. Conversely, the existence of the first plating coating film 46 cannot be confirmed visually on the remaining bottom surfaces 24b, 26b, the first inclined surface 41a, and the second inclined surface 41b. Further, presence of the first plating coating film 46 is less than a lower detection limit enabled by fluorescent X-ray (XRF) analysis.

When electron microscopic (SEM) observation is performed, it is recognized that an extremely small amount of particles, of 3 to 4 ng/cm², also are deposited on the bottom surfaces 24b, 26b, the first inclined surfaces 41a, and the second inclined surfaces 41b. In the following description, these particles are designated as a dispersed coating film, and shall be referred to as a second plating coating film, for the purpose of convenience. However, as described above, the second plating coating film cannot be confirmed visually. Therefore, in addition, the second plating coating film is not shown in the drawings.

On the other hand, in the embodiment of the present invention, the amount of particles (first plating coating film 46) deposited on the horizontal top surfaces 24a, 26a is 30 to 40 μg/cm², which is not less than 10,000 times the amount of particles (second plating coating film) deposited on the bottom surfaces 24b, 26b, the first inclined surfaces 41a, and the second inclined surfaces 41b.

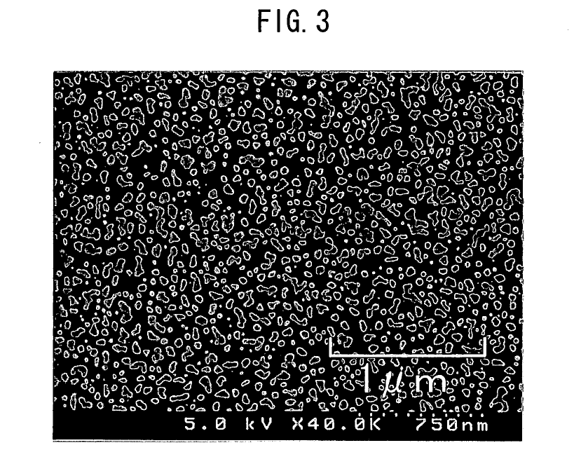

The first plating coating film 46 is visually observed as a uniform film. However, as shown in FIG. 3, which is an SEM photograph at 40000× magnification, it is confirmed through SEM observation that the first plating coating film 46 forms a dispersed coating film in which particles having particle sizes of 20 to 40 μm are scattered and dotted in an island form. That is, the particles forming the first plating coating film 46 have extremely small sizes compared with particle sizes of 3,000 to 8,000 nm that form the plating coating film of the conventional technique.

The coating ratio of the first plating coating film 46 with respect to the horizontal top surfaces 24a, 26a is set at 16% to 70%. Therefore, the contact resistance is reduced considerably on the horizontal top surfaces 24a, 26a, and galvanic corrosion scarcely occurs.

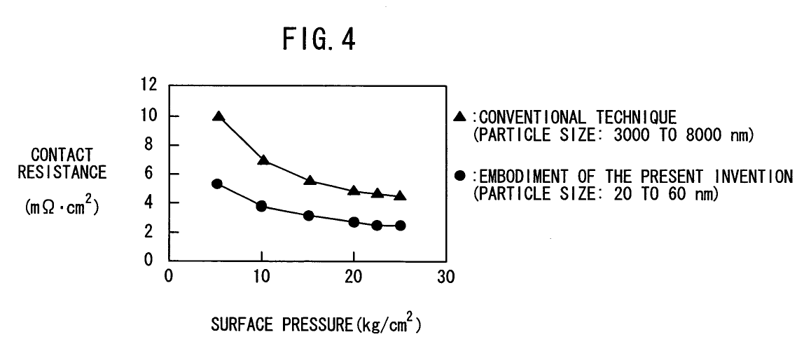

According to the embodiment of the present invention, in which particles forming the plating coating film have small particle sizes and the coating ratio is large as compared with the conventional technique, the contact resistance of the horizontal top surface 24a, 26a is remarkably reduced as compared with the conventional technique, as clearly understood from FIG. 4, which illustrates contact resistance when gold particles are deposited. That is, contact resistance is lowered as compared with the conventional technique, irrespective of the magnitude of the surface pressure (contact pressure with respect to the electrodes 14, 16).

One of gold, rhodium, platinum, or an alloy of two or more thereof, is selected as the material for the first plating coating film 46.

On the other hand, the defect portion 44 is not formed on parts of the passivation film 42 where the bottom surfaces 24b, 26b, the first inclined surfaces 41a, and the second inclined surfaces 41b are subjected to coating.

The preferred thickness of the passivation film 42 is 4 to 5 nm. The principal component of the passivation film 42 differs in the depth direction. The principal component is Cr at the bottom surfaces 24b, 26b, i.e., on the side nearest to the stainless steel. However, substantially at the middle to the surface layer portions in the depth direction, the principal component is Fe.

Next, a method for producing the fuel cell separator 40 shall be explained.

At first, a preformed member, having the same shape as that of the fuel cell separator 40 shown in FIG. 1, is manufactured by means of various forming processes.

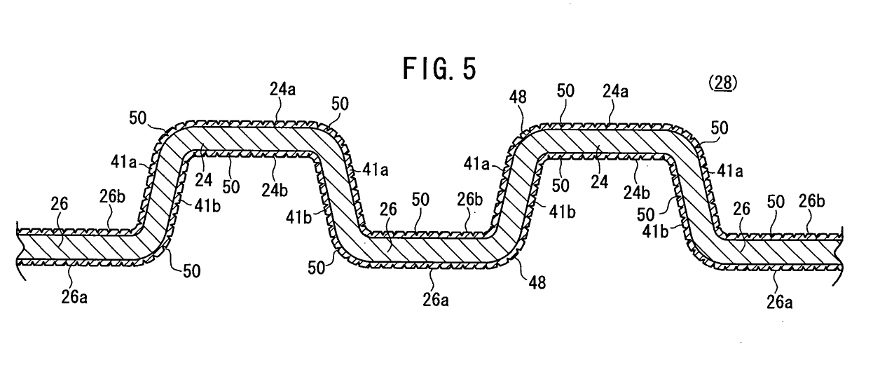

The preformed member is composed of stainless steel. The passivation film 48 is formed on the surface thereof, which is represented by the surface of the wavy portion 28 shown in FIG. 5, as a result of a reaction between the stainless steel and oxygen contained in the air. Defect portions generated when the rolling process is applied, and defect portions generated by execution of a press forming process or the like when the wavy portion 28 is formed, are present over the entire passivation film 48. In the following description, the defect portions are indicated by reference numeral 50.

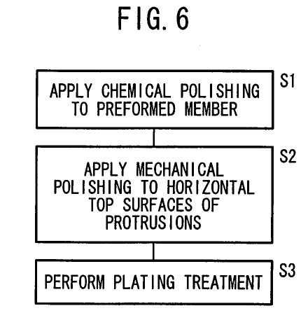

In this embodiment, as depicted in the flow chart shown in FIG. 6, acid washing is applied to the passivation film 48 during the first step S1, mechanical polishing is applied to the horizontal top surfaces 24a, 26a of the first protrusions 24 and the second protrusions 26 during the second step S2, and the first plating coating film 46 is formed during the third step S3.

Specifically, initially, in the first step S1, a preformed member, in which the wavy portion 28 is provided and the passivation film 48 is spontaneously generated, is immersed in a treatment liquid so as to perform acid washing of the passivation film 48. Accordingly, the passivation film 48 is initially removed, and together therewith, the defect portions 50 also are removed.

The treatment liquid used for performing acid washing is not limited. For example, preferred treatment liquids are exemplified by ferric chloride, hydrochloric acid, and nitric acid. For example, a stripping liquid, which is used when the nickel plating coating film is removed, may be used in combination with and in addition to the acid described above.

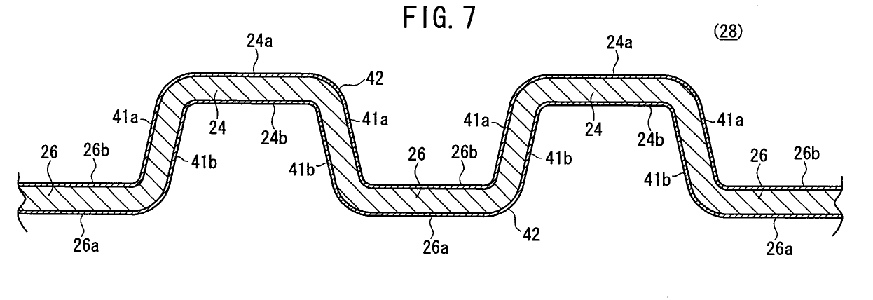

The preformed member, from which the defect portions 50 have been removed together with the passivation film 48, is pulled up from the treating liquid, and a heating treatment is performed at 200 to 280° C. As a result, as shown in FIG. 7, a new passivation film 42, which has a thickness of about 4 to 5 nm, is generated. The principal component differs in the depth direction in the passivation film 42 obtained by performing the heat treatment in the temperature region as described above. That is, the principal component is Cr in the vicinity of the deepest portion disposed near to the fuel cell separator 40 as stainless steel, and the principal component is Fe in the region ranging from the substantially middle portion to the surface layer portion in the depth direction.

In this procedure, if heating is performed at a temperature exceeding 320° C., cracks or the like appear in the passivation film 42, because the coefficient of thermal expansion differs between stainless steel and the passivation film 42 (oxide).

Subsequently, in the second step S2, mechanical polishing is applied to the horizontal top surfaces 24a, 26a of both of the first protrusions 24 and the second protrusions 26. A grinding wheel may be used, for example, in order to perform such mechanical polishing.

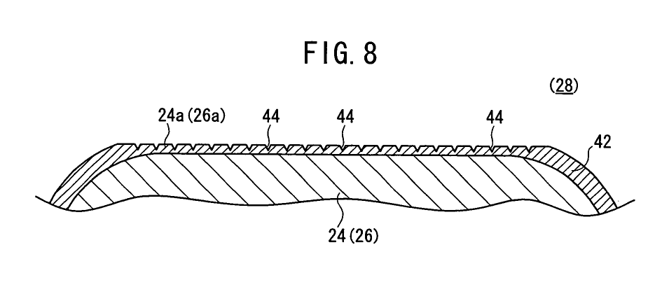

As a result of mechanical polishing, as shown in FIG. 8, the passivation film 42 is partially chipped off or removed. As a result, defect portions 44 are introduced into the passivation film 42. The thickness of the passivation film 42 is about 1.5 to 3 nm at portions where the defect portions 44 are present.

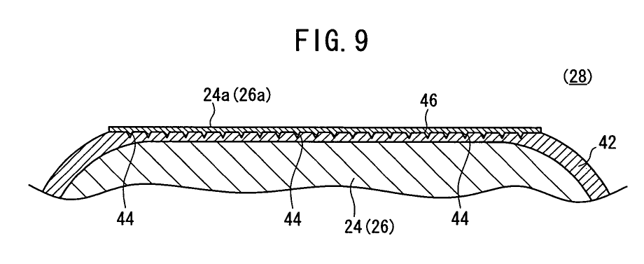

In the third step S3, a plating treatment is applied to the wavy portion 28, in which the defect portions 44 have been provided as described above, thereby forming the first plating coating film 46 as shown in FIG. 9.

An explanation will be made below, exemplifying a case in which a gold plating coating film is formed as the first plating coating film 46. A gold sulfite salt such as Na₃[Au(SO₃)₂], which serves as a raw material for the gold plating coating film, and a complex ion stabilizer that suppresses dissociation of the gold sulfite salt into Au⁺, are added to the plating bath.

For example, Na₃[Au(SO₃)₂] dissociates into Au⁺ via [Au(SO₃)₂]³⁻. The complex ion stabilizer suppresses this dissociation in order to effect stabilization as [Au(SO₃)₂]³⁻. When the complex ion stabilizer is provided as described above, an extremely small amount of Au⁺ exists in the plating bath. Therefore, deposition of particles, i.e., formation of the first plating coating film 46, is scarcely caused at portions at which a nucleus does not exist to facilitate deposition of particles on the wavy portion 28.

In the case of a gold sulfite salt, such as Na₃[Au(SO₃)₂], preferred examples of the complex ion stabilizer include phosphate salts such as NaH₂PO₄ and Na₄P₂O₇.10H₂O, carboxylate salts such as C₆H₅O₇Na₃.2H₂O, and sodium salts such as Na₂SO₃ and Na₂B₄O₇. Of course, all of the above-described components may be simultaneously added.

Concerning concentrations of the respective components, for example, Na₃[Au(SO₃)₂] may be set to 7 g/liter, NaH₂PO₄ may be set to 30 g/liter, Na₄P₂O₇.10H₂O may be set to 30 g/liter, C₆H₅O₇Na₃.2H₂O may be set to 50 g/liter, Na₂SO₃ may be set to 30 g/liter, and Na₂B₄O₇ may be set to 10 g/liter. The same or equivalent effects also are obtained even when dilution is performed, until the concentration of each of the components is 1/7.

Sulfite ST-1, which is a commercially available product available from Electroplating Engineers of Japan Ltd., can be used as the gold sulfite salt. Alternatively, gold cyanide may be used in place of the gold sulfite salt.

When the plating treatment is applied in the plating bath as described above, the defect portions 44 serve as nuclei, and although the complex ion stabilizer is added to the plating bath, the gold particles are deposited relatively easily from the surrounding portions thereof, because the defect portions 44 are present on the horizontal top surfaces 24a, 26a. In other words, gold particles having particle sizes of 20 to 60 μm are deposited, so that they are scattered and dotted in an island form, from starting points of the circumferential portions of the defect portions 44. Finally, the gold particles are deposited at about 30 to 40 μg/cm² over the entire horizontal top surfaces 24a, 26a, so as to provide a visually observable coating film state. That is, as shown in FIGS. 2 and 9, the horizontal top surfaces 24a, 26a are coated with the first plating coating film 46.

During the plating treatment, the coating ratio of the first plating coating film 46 with respect to the horizontal top surfaces 24a, 26a can be adjusted, for example, by controlling the current density and the treatment time. Specifically, when the current density is set to about 0.22 to 0.48 A/cm², and if the treatment time is about 30 seconds, then the coating ratio is within a range of 16% to 70%.

On the other hand, defect portions 44 are scarcely present on the first inclined surfaces 41a, the second inclined surfaces 41b, and the bottom surfaces 24b, 26b that form the back surfaces of the horizontal top surfaces 24a, 26a (see FIGS. 2, 5, and 7), because mechanical polishing of the passivation film 42 is not performed. Further, a complex ion stabilizer is added to the plating bath. Therefore, the deposition velocity of the gold particles is extremely slow on the bottom surfaces 24b, 26b, the first inclined surfaces 41a, and the second inclined surfaces 41b. Gold particles are ultimately deposited in an extremely small amount of about 3 to 4 ng/cm². Therefore, unlike the first plating coating film 46, such gold particles do not undergo growth forming a visually recognizable coating film.

For the reasons described above, the first plating coating film 46 is selectively formed on the horizontal top surfaces 24a, 26a, whereby the fuel cell separator 40 shown in FIG. 1 consequently is obtained.

As described above, according to the embodiment of the present invention, the first plating coating film 46 can be selectively provided on the horizontal top surfaces 24a, 26a, which abut against another member. That is, the positions where the first plating coating film 46 is formed can be limited to only a necessary minimum amount. Therefore, expensive production costs for the fuel cell separator 40 can be avoided, and consequently, the fuel cell separator 40 can be supplied inexpensively.

As clearly appreciated from the above, in the embodiment of the present invention, the first plating coating film 46 can be provided on only necessary portions, by performing an extremely simple operation whereby the plating treatment is performed after acid washing and mechanical polishing have been performed. In other words, complicated operations, which would otherwise be performed, such as masking in order to avoid the formation of the first plating coating film 46 at portions other than the necessary portions, and removal of such masking after formation of the first plating coating film 46, are rendered unnecessary and need not be performed. Further, the manufacture of new types of apparatuses or devices also is unnecessary.

Further, the passivation film 46 is initially removed in the first step S1, and a passivation film 42, in which the defect portions 50 are scarce, is newly provided. Further, in the second step S2, a large number of defect portions 44 are provided on the passivation film 42, and thereafter, the first plating coating film 46 is formed thereon. Accordingly, after the plating treatment, conduction occurs via the first plating coating film 46 that is formed on the horizontal top surfaces 24a, 26a, between the electrodes 14, 16 (see FIG. 10) and the fuel cell separator 40. Therefore, an environment is obtained in which electrical resistance is extremely small.

Further, the first plating coating film 46, which is formed on the horizontal top surfaces 24a, 26a, is a dispersed coating film composed of particles scattered and dotted in an island form. Therefore, even if a corrosion current arises between the first plating coating film 46, composed of gold, rhodium, platinum, or an alloy thereof, and the stainless steel underlayer, the corrosion current is dispersed. Therefore, the passivation film is not destroyed. Consequently, an advantage is obtained in that it is difficult for galvanic corrosion to occur.

Thereafter, if necessary, the fuel cell separator 40 may be placed in an oxidizing environment in order to further strengthen the passivation film 42.

In the embodiment described above, a plating bath, which includes gold sulfite salt, phosphate salt, carboxylate salt, and sodium salt, is used in order to provide the first plating coating film 46, which is composed of gold. However, it is sufficient for at least gold sulfite salt and phosphate salt to be present in the plating bath. For example, only Na₃[Au(SO₃)₂] and NaH₂PO₄ may be added to the plating bath. Alternatively, Na₂SO₃ may also be added, in addition to these two components. Alternatively, a plating bath may be prepared by adding Na₃[Au(SO₃)₂], NaH₂PO₄, Na₂SO₃, and Na₄P₂O₇.10H₂O. In any case, concentrations of the respective components may be within the ranges described above.

It goes without saying that the material for the first plating coating film 46 may be replaced with rhodium, platinum, and other various alloys including, for example, a gold-rhodium alloy.

Further, in this embodiment, the first plating coating film 46 is provided on both horizontal top surfaces 24a, 26a of the first protrusions 24 and the second protrusions 26. However, the first plating coating film 46 may be provided on only one of the horizontal top surfaces 24a, 26a. In this case, mechanical polishing may be applied only to one of the horizontal top surfaces 24a, 26a, on which the first plating coating film 46 is provided.

Further, in the mechanical polishing performed in the second step S2, one or more parts of the passivation film 42 may be chipped off together with the surface layer of the base material (for example, stainless steel or titanium alloy).

When the new passivation film 42 is provided, exposure to air may be utilized in place of heating at a temperature of 200 to 280° C., or alternatively, heating may be performed at a relatively low temperature of up to 140° C. In this case, a passivation film 42 is formed having a thickness of 2 to 3 mm, and which contains Fe as a principal component thereof. When the polishing and plating treatments are performed, as described above, on the preformed member, on which a passivation film 42 is formed as described above, the amount of the first plating coating film 46 is not less than 1,000 times the amount of the second plating coating film, even though the first plating coating film 46 is formed as a dispersed coating film, in which particles having particle sizes of 20 to 40 μm are scattered and dotted in an island form. In the case of the aforementioned deposition amount as well, contact resistance of the horizontal top surfaces 24a, 26a is sufficiently small.

From this fact, it should be clearly appreciated that the amount of deposition of the particles that make up the first plating coating film 46 can be controlled, for example, by using different temperatures when the passivation film 42 is formed.

1. A fuel cell separator comprising a wavy portion including first protrusions and second protrusions, which are disposed alternately and continuously, said first protrusions protruding in a predetermined direction and having horizontal top surfaces, and said second protrusions protruding in a direction opposite to said direction of said first protrusions, and having horizontal top surfaces exposed on a side opposite to a side on which said horizontal top surfaces of said first protrusions are exposed,
wherein a first plating coating film, composed of a dispersed coating film, containing one of gold, rhodium, platinum, and an alloy of two or more thereof, and deposited in an island form as granules having particle sizes of 20 to 60 nm, is provided on said horizontal top surfaces of at least one of said first protrusions and said second protrusions, while a second plating coating film, composed of a dispersed coating film, containing one of gold, rhodium, platinum, and an alloy of two or more thereof, and deposited in an island form as granules having particle sizes of 20 to 60 nm, is provided on back surfaces of said second protrusions or said first protrusions with respect to said horizontal top surfaces, said back surfaces being adjacent to said horizontal top surfaces, and
wherein an amount of said first plating coating film is not less than 1,000 times an amount of said second plating coating film.

2. The fuel cell separator according to claim 1, wherein said amount of said first plating coating film is not less than 10,000 times said amount of said second plating coating film.

3. The fuel cell separator according to claim 1, wherein a passivation film, existing at portions other than said horizontal top surfaces, has a thickness of not less than 4 nm.

4. The fuel cell separator according to claim 1, wherein a coating ratio of said first plating coating film with respect to said horizontal top surfaces is 16% to 70%.

5. A method for producing a fuel cell separator comprising a wavy portion including first protrusions and second protrusions, which are disposed alternately and continuously, said first protrusions protruding in a predetermined direction and having horizontal top surfaces, and said second protrusions protruding in a direction opposite to said direction of said first protrusions and having horizontal top surfaces exposed on a side opposite to a side on which said horizontal top surfaces of said first protrusions are exposed, wherein a first plating coating film, composed of a dispersed coating film, containing one of gold, rhodium, platinum, and an alloy of two or more thereof, and deposited in an island form as granules having particle sizes of 20 to 60 nm, is provided on said horizontal top surfaces of at least one of said first protrusions and said second protrusions, while a second plating coating film, composed of a dispersed coating film, containing one of gold, rhodium, platinum, and an alloy of two or more thereof, and deposited in an island form as granules having particle sizes of 20 to 60 nm, is provided on back surfaces of said second protrusions or said first protrusions with respect to said horizontal top surfaces, said back surfaces being adjacent to said horizontal top surfaces, and wherein an amount of said first plating coating film is not less than 1,000 times an amount of said second plating coating film, said method comprising the steps of:
removing a passivation film existing on said wavy portion provided for said fuel cell separator;
providing a new passivation film on said wavy portion, and then applying mechanical polishing to said horizontal top surfaces of at least one of said first protrusions and said second protrusions, thereby providing defect portions on said passivation film existing on said horizontal top surfaces; and
applying a plating treatment to said fuel cell separator with a plating bath, containing at least one selected from the group consisting of gold complex salt, rhodium complex salt, and platinum complex salt, so as to selectively provide said plating coating film on said horizontal top surfaces using as starting points circumferential portions of said defect portions.

6. The method for producing said fuel cell separator according to claim 5, wherein a complex ion stabilizer is added to a plating liquid when said plating treatment is performed.

7. The method for producing said fuel cell separator according to claim 6, wherein at least one of phosphate salt, carboxylate salt, and sodium salt is added as said complex ion stabilizer.

8. The method for producing said fuel cell separator according to claim 5, wherein said new passivation film is provided by heating said wavy portion to a temperature of 200 to 280° C., after said passivation film existing on said wavy portion (28) has been removed.
